(19) United States
(12) Patent Application Publication
(10) Pub. No.: US 2016/0061423 A1
(43) Pub. Date: Mar. 3, 2016

(54) LIGHT EMITTING DIODE LAMP AND LAMP HOLDER

(71) Applicant: HON HAI PRECISION INDUSTRY CO., LTD., New Taipei (TW)

(72) Inventor: CHI-HSIEN FONG, New Taipei (TW)

(21) Appl. No.: 14/800,900

(22) Filed: Jul. 16, 2015

(30) Foreign Application Priority Data
Sep. 2, 2014 (CN) 201410442027.6

(51) Int. Cl. F21V 19/00; F21V 23/06; F21V 21/002; F21K 99/00

(52) U.S. Cl. CPC F21V 19/004; F21K 9/1355; F21V 23/06; F21V 21/002

(57) ABSTRACT

A Light Emitting Diode (LED) lamp includes an insulated base, a lamp holder, a LED module, a circuit board, a first elastic member and a second elastic member. The lamp holder is coupled to the insulated base and includes a conduction socket, an insulated connecting member coupled to the conduction socket, and a conductive terminal coupled to the insulated connecting member. The LED module is electrically coupled to a circuit board. The circuit board received by the insulated base which includes a main body. The first elastic member is elastically abutted against the conduction terminal of the lamp holder. The second elastic member is elastically abutted against the conduction socket of the lamp holder, wherein the circuit board is electrically coupled to the lamp holder.

### FIELD

The subject matter herein generally relates to a Light Emitting Diode (LED) lamp and a lamp holder for the LED lamp.

### BACKGROUND

A commercial LED lamp usually includes an insulated base for a lamp cover installation, a lamp holder coupled to the insulated base, and a circuit board and a LED module received in the insulated base. The lamp holder includes a conduction terminal and a threaded conduction portion. When assembling the LED lamp, two conduction wires are used. One end of the first wire is soldered on the circuit board, and another end of the first wire is wound around and fixed on the conduction terminal manually. One end of second wire is soldered on the circuit board, and another end of the second wire is wound around and electrically coupled to the outer shell of the threaded conduction portion near the insulated base.

### BRIEF DESCRIPTION OF THE DRAWINGS

Implementations of the present technology will now be described, by way of example only, with reference to the attached figures.

FIG. 1 is an isometric view of a LED lamp.

FIG. 2 is an exploded assembly diagrammatic view of the LED lamp of FIG. 1.

FIG. 3 is a cutaway view along line III-III of the LED lamp of FIG. 1.

FIG. 4 is an isometric view of a circuit board with elastic members of the LED lamp of FIG. 3.

FIG. 5 is a cutaway view of another embodiment of the LED lamp.

FIG. 6 is an isometric view of a circuit board with elastic members of the LED lamp of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

The term “comprising,” when utilized, means “including, but not necessarily limited to”; it specifically indicates open-ended inclusion or membership in the so-described combination, group, series and the like.

The present disclosure is in relation to a Light Emitting Diode (LED) lamp and a lamp holder for the LED lamp

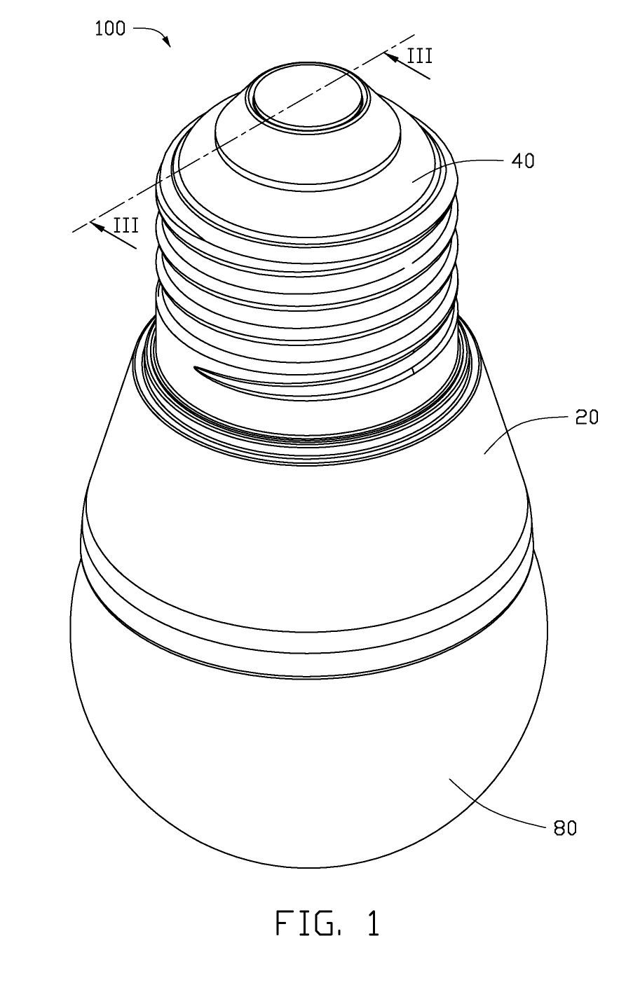

FIG. 1 illustrates a LED lamp 100. The LED lamp 100 comprises an insulated base 20, a lamp holder 40 coupled to the insulated base 20, and a lamp cover 80 coupled to the insulated base 20.

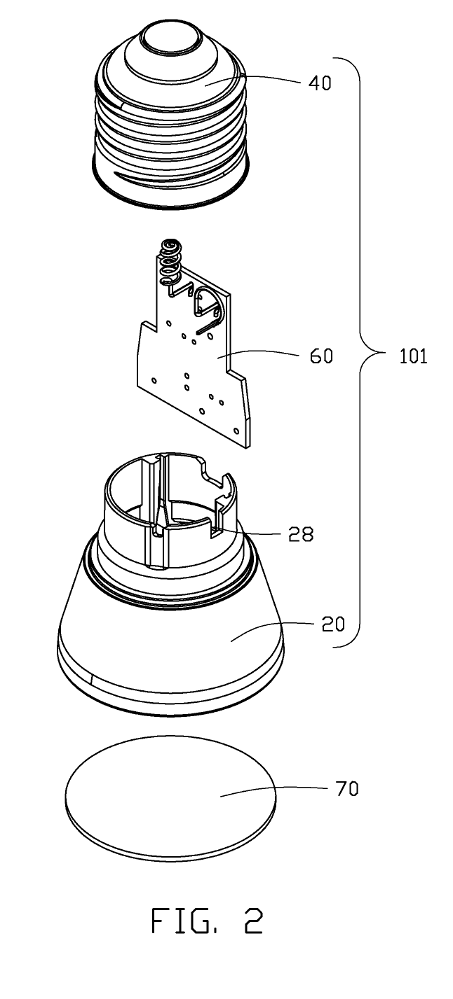

FIG. 2 illustrates an embodiment of the LED lamp 100. The LED lamp 100 comprises a LED lamp head 101 and the lamp cover 80. The LED lamp head 101 further comprises the lamp holder 40, the insulated base 20, and a circuit board 60 is received in the insulated base 20. The LED module 70 is electrically connected with circuit board 60. The lamp cover 80 is coupled to the LED module 70.

In the embodiment, the LED lamp 100 is a LED bulb. In other embodiments, the LED lamp 100 can be LED tube, LED down light or LED flat light.

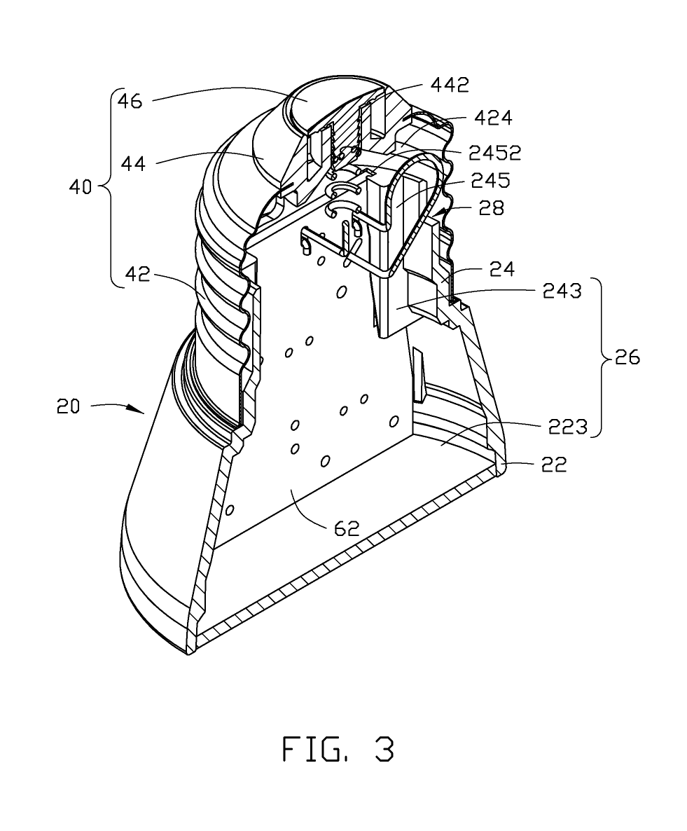

FIG. 3 illustrates an embodiment of the insulated base 20 and the lamp holder 40. The insulated base 20 comprises a first assembling portion 22 and a second assembling portion 24 coupled to the first assembling portion 22. The first assembling portion 22 is a hollow and cylindrical structure. The diameter of the first assembling portion 22 is reduced along the direction toward the second assembling portion 24. A first receiving space 223 is formed from the surrounding inner surface of the first assembling portion 22. The second assembling portion 24 is a hollow cylindrical structure. A second receiving space 243 is formed from the surrounding inner surface of the second assembling portion 24. A receiving container 26 is defined by combining of the first receiving space 223 and the second receiving space 243. The circuit board 60 is received by the receiving container 26.

The lamp holder 40 comprises a conduction socket 42, an insulated connecting member 44 and a conduction terminal 46. The conduction socket 42 is coupled to the second assembling portion 24. The conduction socket 42 has an approximately hollow and cylindrical structure with a threaded shell. A receiving recess 424 is provided in the conduction socket 42. The receiving recess 424 is coupled to the receiving container 26. The insulated connecting member 44 is coupled to the conduction socket 42 and defines an installation recess 442. The installation recess 442 is coupled to the receiving recess 424. The conduction terminal 46 is provided in the installation recess 442. The end of the conduction terminal 46 close to the receiving recess 424 is extended from the installation recess 442 to the circuit board 60. In this embodiment, the conduction terminal 46 is a rivet.

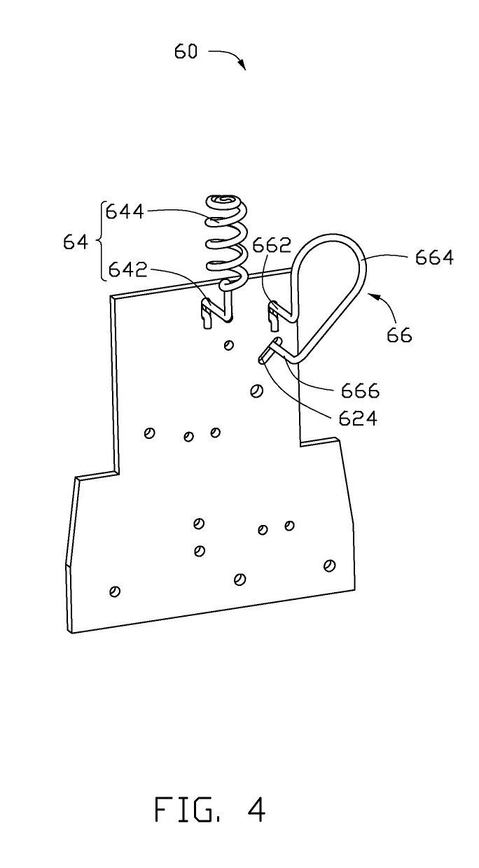

FIG. 4 is a perspective view of the circuit board 60 provided inside the insulated base 20. The circuit board 60 comprises a main body 62, a first elastic member 64 coupled to the main body 62, and a second elastic member 66 coupled to the main body 62. The main body 62 is a plate structure and is received by the receiving container 26 of the insulated base 20.

The inner surface of the second assembling portion 24 toward the second receiving space 243 has two installation bars 245. Two installation recesses 2452 are defined on the two installation bars 245. The two ends of the main body 62 near the second assembling portion 24 are installed in the corresponding installation recess 2452. An orientation portion 624 close to the end of insulated connecting member 44 is provided on the main body 62. In this embodiment, the orientation portion 624 is a hole. In some other embodiments, the orientation portion 624 can be a recess, a groove or other structures.

In the embodiment, the first elastic member 64 and the second elastic member 66 are both made of conductive material. The first elastic member 64 is electrically coupled to the conduction terminal 46. The second elastic member 66 is electrically coupled to the conduction socket 42. The first elastic member 64 comprises a fixing terminal 642 and an elastic extension 644 extending from the fixing terminal 642 toward the conduction terminal 46. The fixing terminal 642 is securely soldered on the main body 62 of the circuit board 60. The elastic extension 644 is a spiral structure. The end of the elastic extension 644 away from the fixing terminal 642 is elastically abutted against the conduction terminal 46.

The second elastic member 66 comprises a holding terminal 662, an abutting portion 664 and a moving terminal 666. The holding terminal 662 is securely soldered on the main body 62 of the circuit board 60. The abutting portion 664 is bent from the holding terminal 662 to the conduction socket 42 and is partially abutted against the conduction socket 42. In the embodiment, a groove 28 is provided on the insulated base 20 located near the second elastic member 66. The abutting portion 664 is placed in the groove 28 and elastically abutted against the inner wall of the conduction socket 42. The moving terminal 666 is extended from the abutting portion 664 away from the holding terminal 662 toward the main body 62. The end of the moving terminal 666 is received by the orientation portion 624 of the main body 62. When the abutting portion 664 of the second elastic member 66 receives forces from the conduction socket 42, the end of the moving terminal 666 moves along the orientation portion 624 away from the groove 28. When the force disappears, the end of the moving terminal 666 returns to the default setting due to the elastic resilience. The orientation portion 624 is configured to limit the movement scope of the moving terminal 666.

The LED module 70 is provided on the end of the insulated base 20 near the lamp cover 80 and is electrically coupled to the circuit board 60. The lamp cover 80 is a transparent structure. The one side of the lamp cover is coupled to the insulated base 20. The lamp cover 80 covers the LED module 70.

In assembly, the fixing terminal 642 of the first elastic member 64 and the holding terminal 662 of the second elastic member 66 are both soldered on the circuit board 60. The main body 62 of the circuit board 64 is received by the installation recess 2452 of the insulated base 20 and is fixed on the installation recess 2452. The second elastic member 66 is provided outside the groove 28 of the insulated base 20. The lamp holder 40 is put on the insulated base 20 so that the first elastic member 64 can be elastically abutted against the conduction socket 42, and the second elastic member 66 can be elastically abutted against the conduction terminal 46.

Because the elastic components are used in the assembly of the LED lamp 100 and LED lamp head 101, for example, the lamp holder 40 is put on the insulated base 20 so that the first elastic member 64 and the second elastic member 64 can be separately and elastically abutted against the conduction socket 42 and the conduction terminal 46, therefore, it is more convenient to assemble the LED lamp 100 without needing to deal with the extra length of wire or high frequency caused by bent wires.

In another embodiment, the first elastic member 64 and the second elastic member 66 are not limited to be soldered to the circuit board 60. The connection method can be replaced by buckle or magnetic connection or other connection methods.

In another embodiment, the groove 28 of the insulated base 20 is not used. The second elastic member 66 is elastically abutted against the conduction socket 42 passing through the end of the second assembling portion 24 of the conduction socket 42.

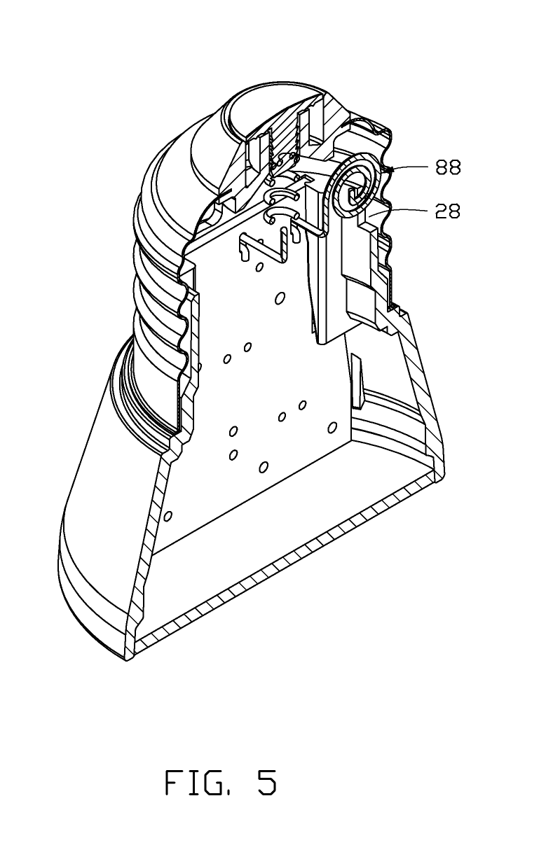

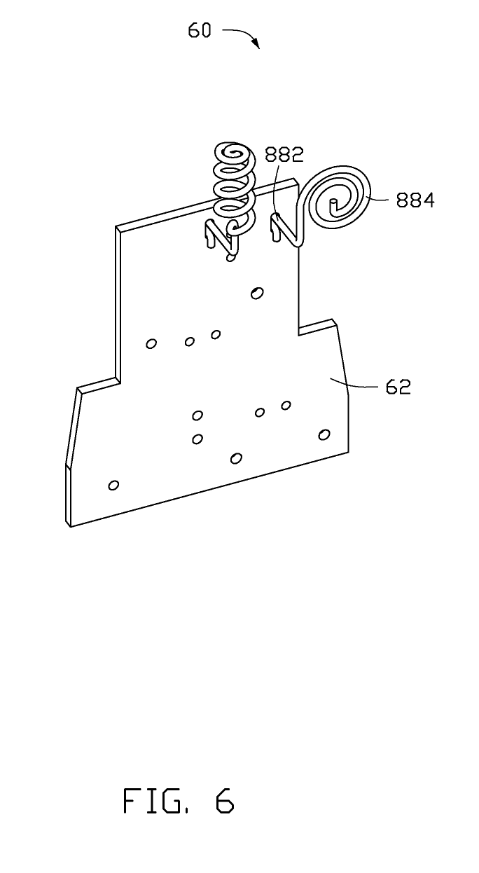

FIG. 5 and FIG. 6 illustrate in another embodiment of the LED lamp 100. The difference is that a second elastic member 88 is a partial moving member. The second elastic member 88 comprises a holding terminal 882 and an abutting portion 884. The holding terminal 882 is securely soldered on the main body 62 of the circuit board 60. The abutting portion 884 is a circular structure and is abutted against the inner wall of the conduction socket 42. Due to this structure, the second elastic member 88 has increased strength.

In another embodiment, the second elastic member 88 is not limited in a circular structure. The second elastic member 88 can be a threaded structure or others.

The embodiments shown and described above are only examples. Many details are often found in the art such as the other features of a LED lamp and a lamp holder for the LED lamp. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A light emitting diode (LED) lamp comprising:
an insulated base;
a lamp holder coupled to the insulated base and comprising:
a conduction socket;
an insulated connecting member coupled to the conduction socket, and
a conduction terminal coupled to the insulated connecting member;
a circuit board received by the insulated base, wherein the circuit board comprises a main body of the circuit board;
a LED module electrically coupled to the circuit board;
a first elastic member elastically abutted against the conduction terminal of the lamp holder; and
a second elastic member elastically abutted against the conduction socket of the lamp holder, wherein the circuit board is electrically coupled to the lamp holder.

2. The LED lamp of claim 1, wherein a groove is provided on the insulated base where the groove is located near the second elastic member, and the second elastic member is passed through the groove and is elastically abutted against the inner wall of the conduction socket.

3. The LED lamp of claim 1, wherein the second elastic member further comprises a holding terminal, an abutting portion and a moving terminal, the holding terminal is fixed on the main body of the circuit board, the abutting portion is bent from the holding terminal to the conduction socket and is partially abutted against the inner wall of the conduction socket, and the moving terminal is extended from the abutting portion far away from the holding terminal toward the main body.

4. The LED lamp of claim 3, wherein an orientation portion close to the end of the insulated connecting member is provided on the main body, and the end of the moving terminal is received by the orientation portion of the main body.

5. The LED lamp of claim 4, wherein the orientation portion is a hole or a recess.

6. The LED lamp of claim 3, wherein the abutting portion is a circular structure and is abutted against the inner wall of the conduction socket.

7. The LED lamp of claim 1, wherein the first elastic member comprises a fixing terminal and an elastic extension extending from the fixing terminal toward the conduction terminal, the fixing terminal is coupled to the main body of the circuit board is elastically abutted against the conduction terminal.

8. The LED lamp of claim 1, wherein the elastic extension is a spiral structure.

9. The LED lamp of claim 1, wherein the LED lamp further comprises a lamp cover, and the LED module is provided on the end of the insulated base near the lamp cover and is electrically coupled to the circuit board.

10. The LED lamp of claim 1, wherein the insulated base comprises a first assembling portion and a second assembling portion coupled to the first assembling portion, a first receiving space is formed from the surrounding inner surface of the first assembling portion, a second receiving space is formed from the surrounding inner surface of the second assembling portion, a receiving container is defined by combining the first receiving space and the second receiving space, and the circuit board is received by the receiving container.

11. The LED lamp of claim 10, wherein the first assembling portion is a hollow and cylindrical structure, and the second assembling portion is a hollow and cylindrical structure.

12. The LED lamp of claim 10, wherein the conduction socket is coupled to the second assembling portion, the conduction socket has a hollow and cylindrical structure with a threaded shell.

13. The LED lamp of claim 12, wherein a receiving recess is provided in the conduction socket, the receiving recess is coupled to the receiving container, the insulated connecting member is coupled to the conduction socket, the insulated connecting member comprises an installation recess, the installation recess is coupled to the receiving recess, the conduction terminal is provided in the installation recess, and the end of the conduction terminal close to the receiving recess is extended from the installation recess to the circuit board.

14. The LED lamp of claim 1, wherein the inner surface of the second assembling portion has two installation bars, two installation recesses are defined on the two installation bars, and the two ends of the main body near the second assembling portion are installed in the corresponding installation recess.

15. The LED lamp of claim 1, wherein the second elastic member is a partial moving member.

16. The LED lamp of claim 15, wherein the second elastic member comprises a holding terminal and an abutting portion, the holding terminal is securely soldered on the main body of the circuit board, and the abutting portion is abutted against the inner wall of the conduction socket.

17. The LED lamp of claim 15, wherein the second elastic member is a threaded structure.

18. The LED lamp of claim 1, wherein the first elastic member and the second elastic member are both made of conductive material.

19. The LED lamp of claim 1, wherein the conduction terminal is a rivet.

20. A LED lamp head comprising:
an insulated base;
a lamp holder coupled to the insulated base and comprising:
a conduction socket;
an insulated connecting member coupled to the conduction socket, and
a conduction terminal coupled to the insulated connecting member;
a circuit board received by the insulated base, wherein the circuit board comprises a main body of the circuit board;
a LED module electrically coupled to the circuit board;
a first elastic member elastically abutted against the conduction terminal of the lamp holder; and
a second elastic member elastically abutted against the conduction socket of the lamp holder, wherein the circuit board is electrically coupled to the lamp holder.
